(19) United States
(12) Patent Application Publication
(10) Pub. No.: US 2007/0157705 A1
(43) Pub. Date: Jul. 12, 2007

(54) Leak detection system with addressable sensors

(76) Inventors: Arnold C. Bilstad, Deerfield, IL (US); James Audo, Deerfield, FL (US)

Correspondence Address: EVEREST INTELLECTUAL PROPERTY LAW GROUP, P. O. BOX 708, NORTHBROOK, IL, 60065, US

(21) Appl. No.: 11/650,718

(22) Filed: Jan. 8, 2007

Related U.S. Application Data
(60) Provisional application No. 60/757,134, filed on Jan. 6, 2006.

(51) Int. Cl. G01M 3/08

(52) U.S. Cl. 73/49.1

(57) ABSTRACT

The present invention provides a leak detection system for a double pipeline having an inner pipe, an outer pipe and an interstitial space therebetween. The system includes: (1) a first sensor and a second sensor spaced from one another and associated with the double pipeline, the first sensor and the second sensor being capable of sensing a change in a physical condition within the interstitial space indicative of a fluid leak and of generating a signal indicating a fluid leak detection, each of the first sensor and the second sensor having a unique address; and (2) a control coupled with the first detector and the second detector and responsive to the signal indicating fluid leak detection; the control being capable of reporting the address of the first sensor or the second sensor that sent the signal indicating fluid leak detection.

### CROSS-REFERENCE TO RELATED APPLICATION

This application claims priority to U.S. Provisional Patent Application Ser. No. 60/757,134 filed on Jan. 6, 2005, which is incorporated herein by reference and made a part hereof.

### FEDERALLY SPONSORED RESEARCH OR DEVELOPMENT

Not Applicable.

### BACKGROUND OF THE INVENTION

1. Technical Field

The present invention provides an alarm system for detecting fluid leaks within an interstitial space of a double containment pipeline system. A double containment pipeline has two concentrically mounted pipes having an inner pipeline, an outer pipeline and the interstitial space therebetween. The alarm system includes, in a preferred form of the invention, a plurality of spaced fluid sensors, placed at strategic locations along the length of the pipeline, to detect fluid leakage from the inner pipeline into the interstitial space. Each sensor contains a unique identification code, which allows for sampling the condition of the sensor and pinpointing a location of a leak in the pipeline system. An electronic control system monitors the sensors continuously, actuates audible and/or visual alarms when leak detection occurs, and provides an event log that displays the time when each individual sensor has detected a leak.

2. Background Art

Double containment pipeline systems are used for safety and to prevent contamination of the environment or the fluid itself. An inner pipe transports the fluid while an outer pipe contains the fluid in the event of a breach of the inner pipe. If an pipe failure occurs, it is desirable to immediately know the location of the failure so that remedial action can be performed. To that end, a variety of leak detection systems have been developed for that purpose.

One type of leak detection system disclosed in U.S. Pat. No. 5,343,191 physically partitions an interstitial space into zones and monitors each zone with an external sensor that is home-run wired to an alarm monitor. Systems of this type add significant installation cost and complexity due to the requirement for physical partitions and the individual home-run wiring.

Another type of leak detection system—such as those disclosed in U.S. Pat. Nos. 5,410,255 and 5,015,958—utilize special cables as sensors to determine the location of leaks. Systems of this type are complex and costly to build and install. Installation of cables into the interstitial space is often difficult as well. If a leak occurs and propagates a length of the cable will be wetted thereby diminishing the accuracy of determining the location of the origin of the leak. Further, a wetted cable will continue to signal the presence of a leak long after the fluid has been removed. These cables must be dried out before they will function properly and can be returned to normal service. Drying the cables can be very difficult and time consuming, especially in a below grade installation.

### BRIEF DESCRIPTION OF THE DRAWINGS

FIG. 1 is a schematic representation of an alarm and leak detection system;

FIG. 2 is an end view of a double containment pipeline; and

FIG. 3 is a circuit diagram for a charge transfer detector.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

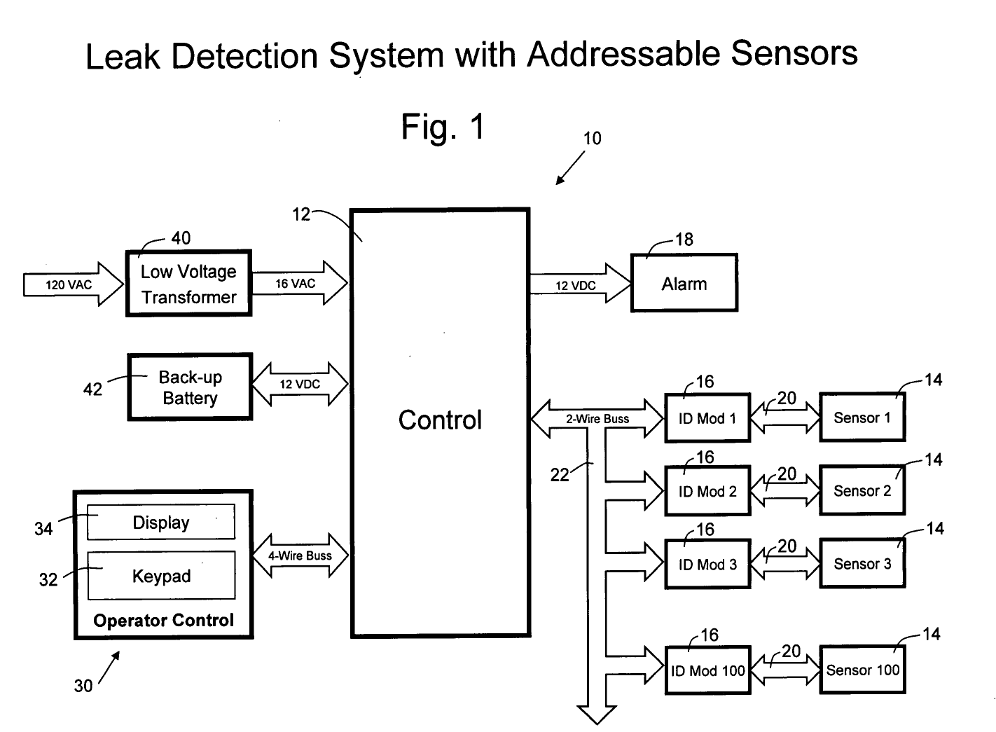

FIG. 1 shows a leak detection system 10 that is low cost and simple to install and operate. The system includes a control 12, a plurality of sensors 14 each associated with a unique address identifier module 16 through connections 20, and each ID module 16 coupled to the control 12 through line 22. In a preferred form of the invention, the control 12 will have an operator control 30 having an input device 32 such as a keyboard a display device 34 and an alarm 36. The control will also have a source of electrical power including a low voltage transformer 40 for converting 120 VAC or other voltage to a lower voltage such as 16 VAC and will have a battery back up unit 42. The control 12 can be a computer or hard-wired circuitry. Suitable computers include, for example, PCs, Apple computer, Macs, and alarm panels such as those sold by DSC under the trademark MAXSYS® and sold by GE under the trademark INTERLOGIX.

Suitable sensors include those that are capable of detecting a change in a physical condition proximate the location of the sensor such as a change in the conductivity, the capacitance, the density and the resistance. In a preferred form of the invention, the sensor will be connected to an integral ID module 16 or an ID module 16 separate from the sensor but coupled thereto through wiring to form an addressable sensor. The present invention contemplates using any number of sensors from one sensor to a plurality of sensors such as from 2 to 100 sensors or in excess thereof.

Line 22 coupling each ID module 16 to the control 12 can be physically connected by, for example, a common wire, such as a two-wire bus, or will be coupled by radio frequency transmitter associated with the ID module 16 to an RF receiver associated with the control 12. It is also contemplated utilizing a combination of wired and wireless type couplings between the ID modules 16 and the control 12.

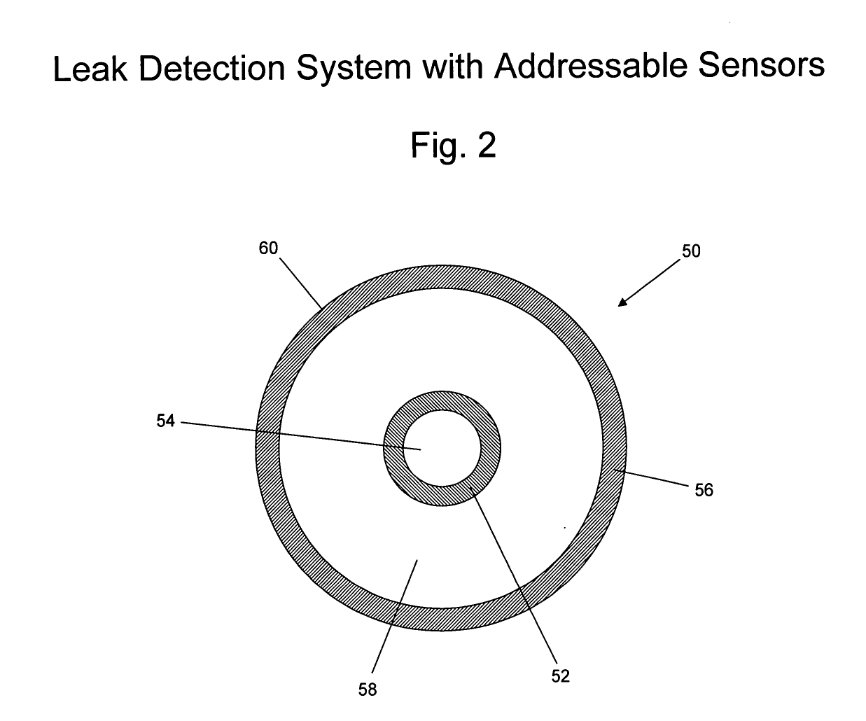

The sensors 14 are installed at strategic locations within a double containment piping system 50 (FIG. 2) having an inner pipe 52 defining a fluid pathway 54, an outer pipe 56 concentrically mounted thereto with an interstitial space 58 therebetween and the outer pipe 56 having an outer surface 60. The sensors 14 can be positioned either in the interstitial space or on the outer surface 60 of the outer pipe 56 with no need for zone partitions. The ID modules 16, in wired embodiments, are preferably electrically connected in parallel (any combination of daisy chain, T-tap, and/or home-run) via a 2-wire cable 22 that simultaneously provides power from the control 12 as well as a pathway for 2-way communications. In the event of a fluid leak from the inner pipe 52 into the interstitial space 58, the sensor closest to the leak will immediately send a “leak-detected” signal to the control 12. Subsequently, other sensors will transmit “leak detected” signals to the control 12 as the leak propagates. In a preferred form of the invention, the control 12 is capable of generating an event log to provide a chronologic history of the events listing the date, time and the address, and therefore, the location of the fluid leak. After the leakage problem has been corrected and the interstitial space drained, the sensors will be immediately ready to do their job again.

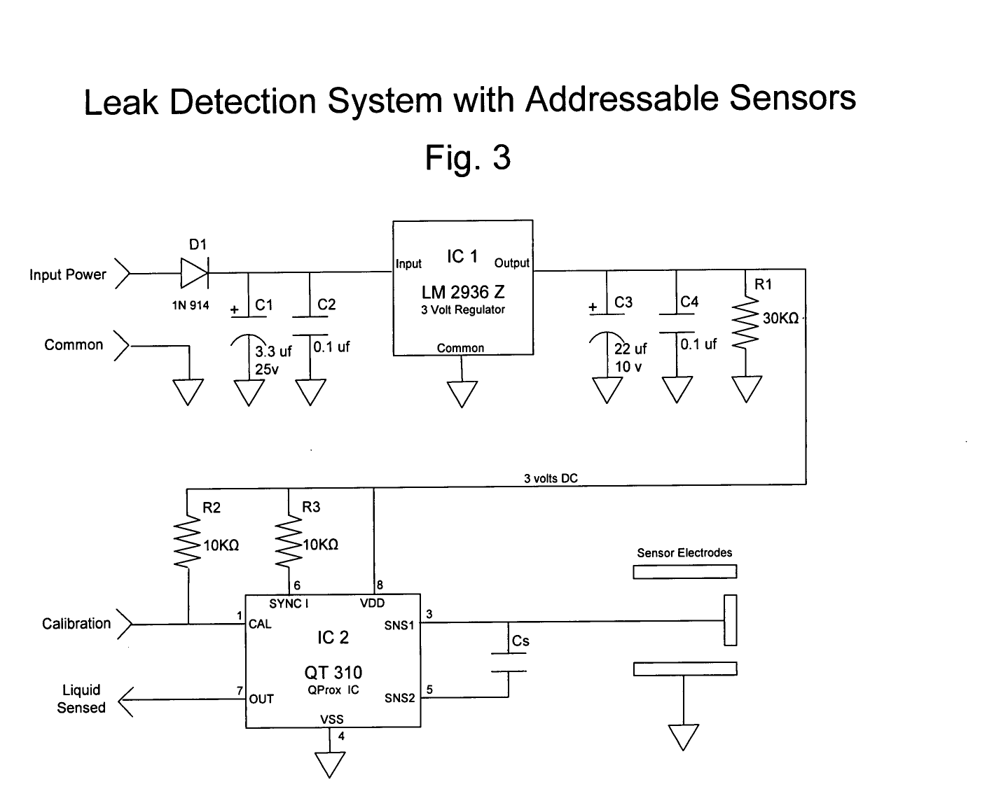

FIG. 3 shows a circuit diagram 50 for a preferred sensor 14 of the present invention. The circuit provides a member for detecting the absence or presence of liquids without direct electrical contact. Although the circuit can operate as a stand-alone module with separate DC power, it is designed to interface with an addressable contact input module associated with control 12. One suitable addressable contact input module includes a DSC AMP-701 Addressable Contact Input Module—a component of the DSC MAXSYS® Security System. The PGM terminals of one preferred controller, the DSC MAXSYS® 4020 Control Panel, provides two-wire power and signal communications to the AMP-701 Addressable Contact Input Module. Power for the circuit comes from the same two-wire power used by the AMP-701 while an additional third wire connects a liquid sensed output of the circuit 50 to a Switch Contact Input of the AMP 701.

In a preferred form of the invention, the circuit 50 is a regulated DC voltage circuit having a 3-Volt Regulator (IC 1). Electrical power enters the circuit via common and input power connections. The Diode (D1) rectifies the AC power signal, the 3.3 μf Capacitor (C1) stores the unregulated DC voltage, and the parallel 0.1 μf Capacitor (C2) filters out high frequency noise. This unregulated DC voltage is the input to the 3-Volt Regulator (IC 1), which in turn produces regulated 3 volts DC at its output. The 22 μf Capacitor (C3) stores the regulated DC output and the parallel 0.1 μf Capacitor (C2) filters out high frequency noise. The 30 KΩ Resistor (R1) provides the appropriate load current for the 3-Volt Regulator (IC 1).

The circuit 50 also includes the QProx™ (IC 2) charge transfer sensor chip. This sensor chip is powered by regulated 3 volts DC connected to VDD (Pin 8) and a Common connection to VSS (Pin 4). Synchronization, which is not required, is disabled on SYNC_I (Pin 6) via 10 KΩ Resistor (R3) connected to regulated 3 volts DC. Sensing takes place between the charge transfer Sensor Electrodes; E1 is connected to SNS1 (Pin 3) and E2 is connected to Common. The Sensor Capacitor (Cs) is connected between SNS1 (Pin 3) and SNS2 (Pin 5) and functions as a reference. Calibration is biased to the off condition via Resistor (R2) connected to regulated 3 volts and the DC CAL (Pin 1). To calibrate, the CAL (Pin 1) is momentarily connected to Common. The liquid sensed signal on OUT (Pin 7) is connected to the switch contact input of the AMP-701.

In practice, the circuit 50 is installed into a non-conductive housing with associated sensor electrodes designed to detect the presence of fluid. During set-up, the QProx™ (IC 2) is programmed for the Object Mode, which allows the device to make and store a measurement when the calibration input is connected to common. Multiple measurements are made, initially with no fluid present and subsequently with fluid present. The QProx™ IC (IC 2) is then programmed to operate in the BG2 Mode with the detection threshold value set between the previously measured values of fluid present and fluid not present. When fluid is present during normal operation of the circuit and the threshold value is exceeded, a Liquid Sensed signal is sent to the AMP-701, which in turn notifies the Control to alarm. Since each AMP-701 has a unique address, the Control can provide the user with the alarm time & location history record.

The QProx™ charge transfer technology was developed by The Quantum Research Group and is disclosed in U.S. Pat. Nos. 5,682,032 and 5,730,165 each of which is incorporated in their entirety by reference and made a part hereof.

Also, in a preferred form of the invention, the control 12 using the alarm 36 will generate an audible and/or visual indication of a leak detection event.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A leak detection system for a double pipeline having an inner pipe, an outer pipe and an interstitial space therebetween, the system comprising:
a first sensor and a second sensor spaced from one another and associated with the double pipeline, the first sensor and the second sensor each capable of sensing a change in a physical condition within the interstitial space indicative of a fluid leak and of generating a signal indicating a fluid leak detection, each of the first sensor and the second sensor having a unique address; and
a control coupled with the first detector and the second detector and responsive to the signal of a fluid leak detection; the control being capable of reporting the address of the first sensor or the second sensor that sent the signal indicating fluid leak detection.

2. The system of claim 1 wherein a portion of the first sensor extends into the interstitial space.

3. The system of claim 1 wherein the double pipeline has an outer wall and the first sensor is mounted to the outer wall.

4. The system of claim 1 wherein the change in physical condition is a change in a physical property selected from the group consisting of: the conductivity, the capacitance, the density and the resistance.

5. The system of claim 1 further comprising an alarm indicator associated with the control and responsive to the signal indicating receipt of the leak detection signal.

6. The system of claim 5 wherein the control is capable of generating a log of the date and time and sensor address where leak detection occurred.

7. The system of claim 1 wherein the first sensor is coupled to the control by either a wire or a radio frequency transmission.
